(19) United States
(12) Patent Application Publication
(10) Pub. No.: US 2026/0287741 A1
(43) Pub. Date: Sep. 24, 2026

(54) TAIL GATE SENSOR

(71) Applicant: Evian Anko, Shelby Twp., MI (US)

(72) Inventor: Evian Anko, Shelby Twp., MI (US)

(21) Appl. No.: 19/254,303

(22) Filed: Jun. 30, 2025

Related U.S. Application Data
(63) Continuation-in-part of application No. 18/120,592, filed on Mar. 13, 2023, now abandoned.
(60) Provisional application No. 63/320,420, filed on Mar. 16, 2022.

(51) Int. Cl. G01S 15/08; B60J 5/10; G08B 21/18

(52) U.S. Cl. CPC G01S 15/08; B60J 5/102; B60J 5/107; G08B 21/182

(57) ABSTRACT

The present invention provides a system for preventing a vehicular lift gate from encountering an overhead obstruction includes a short-range RF transmitter key fob for actuating sensors to enable the sensors to modulate and demodulate radio frequencies. The fob is in communication with a vehicle BCM which in turn communicates with at least one ultrasonic sensor, which may be mounted in the rear bumper of a vehicle or on the lift gate, itself, for sensing the proximity of the lift gate to an overhead obstruction. The sensor detects the absence or presence of the obstruction and sends a signal of such status back to the BCM which, in turn, enables or precludes or interrupts the path of travel of the lift gate. The BCM includes a modified open source software for enabling detection of an overhead obstruction.

### CROSS REFERENCE TO RELATED APPLICATIONS

This Application is a Continuation in Part Application of co-pending U.S. patent application Ser. No. 18/120,592, filed on Mar. 13, 2023, for “Tailgate Sensor” which, in turn, is a Completion Application of U.S. Provisional Application Ser. No. 63/320,420 filed on Mar. 16, 2022, the disclosure of which is hereby incorporated by reference, including the drawings.

### PRIOR ART

As is known to those skilled in the art to which the invention pertains many vehicles such as SUVs, vans, etc. have tail or lift gates or rear door panels or trunk lids which open and close to enable loading of a cargo bay area or the like. Many of these tail gates are either in-vehicle or remotely operated and can be actuated to open and close by the driver through a relay located in the passenger compartment.

As is taught in the above identified co-pending application, in a typical tail gate equipped vehicle, ordinarily a key fob is used to remotely open and close the tail gate. Ordinarily, a radio frequency (RF) is used as the activation signal. Typically, a key fob has two identifications (ID), namely, an intelligent key ID and a Near Vertical Incidence Skywave (NVIS) ID. A body Control Module (BCM) inside the vehicle performs the ID verification between itself and the key fob when an RF signal is transmitted into the detection area of the normal vehicle rear end antenna to enable it to perform the tail gate operation. When the BCM receives the tailgate open request signal, it reads the input from an ultrasonic sensor. If an object is not detected, then it operates the tailgate release solenoid by opening the tail gate. If the RFID signals match, and the sensor detects an object, the BCM will finish its command by sending a serial data message to the instrument cluster via a Controller Area Network (CAN) which will then either display the tail gate open warning or sound an audible alarm to inform the user that the tail gate did not open due to the object detection.

As is also known, tail gates do not travel in a vertical pathway but, rather, in an orbital pathway. Thus, if an object, such as a person, travels or is situated within the orbital path, he or she may be injured if the operator does not see or detect the presence of such person within that orbital path when the tail gate is being opened or closed unless the vehicle meets ISO 26262 functional safety standards and there is no malfunction. Also, the standard does not address an overhead obstruction such as a parking structure roof or a retracted garage door.

Further, it is to be appreciated that where a key fob is used to remotely actuate a tail gate, oftentimes it is impossible to detect the presence of a person or object within the path of travel since the vehicle is not in the view of the operator.

Thus, it is to be appreciated regardless if the vehicle meets the functional safety standard that a major advance would be provided by a remote key fob which can initiate a signal to at least one sensor that can detect the presence of an object within the orbital path of a tail gate to prevent it from being actuated to either open or close, including being in proximity to an overhead obstruction, etc. It is this to which the present invention is directed.

### BACKGROUND OF THE INVENTION

The present invention pertains to vehicular tail gates. More particularly, the present invention concerns remotely controlling movement or non-movement of a vehicular tail gate if an object is detected in the path of travel, including overhead obstruction.

### SUMMARY OF THE INVENTION

The present invention provides an ordinary short-range RF transmitter key fob which comprises an RF transmitter for actuating sensors to enable the sensors to modulate and demodulate radio frequencies.

The fob is in communication with the vehicle BCM which in turn communicates with at least one ultrasonic sensor, or equivalent thereof, which may be mounted in the rear bumper of a vehicle or on the lift gate, itself, for sensing the proximity of the lift gate to an overhead obstruction.

For a more complete understanding of the present invention, reference is made to the following detailed description and accompanying drawing. In the drawing, like reference characters refer to like parts throughout the several views in which:

### BRIEF DESCRIPTION OF THE DRAWINGS

FIG. 1 is an illustration of a present key fob;

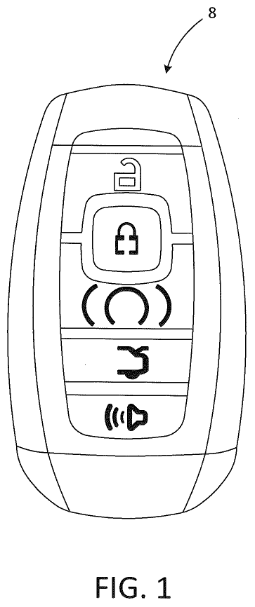

FIG. 2 is a side view of a vehicle depicting a tail gate orbital path;

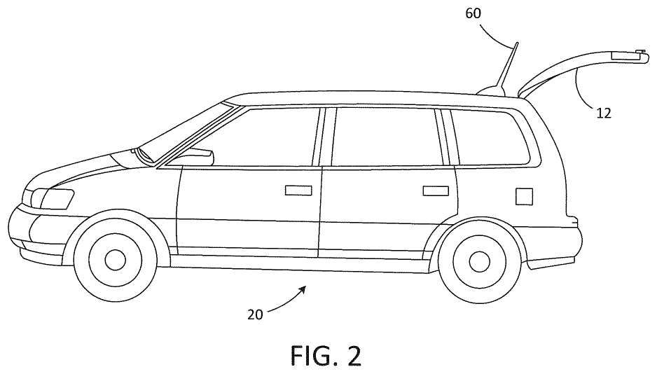

FIG. 3A is a flow chart depicting a data stream for the key fob using a transceiver hereof;

FIG. 3B is a flow chart depicting a data stream for the key fob using a transducer;

FIG. 3C is a flow chart depicting a data stream for detecting the proximity to an overhead obstruction; and

FIG. 4 is a rear view of a vehicle showing the sensors installed thereon and the field of coverage.

### DETAILED DESCRIPTION OF THE INVENTION

At the outset, it is to be noted that in the above-referenced co-pending application, the sensing is ordinarily confined to the volume between a ground surface and the roof of a vehicle due to the limitations of the Body Control Module (BCM) of the vehicle. The present invention expands upon this by providing means and a method for interrupting a path of travel if an overhead obstruction is encountered or precluding travel.

In accordance herewith and with reference to the drawing, there is provided a (remotely operated) key fob 8 which typically includes a signal emitter 10 for remotely coordinating the opening and closing of a vehicle tail gate 12 in cooperation with a vehicle's BCM.

The system hereof also includes at least one sensor 14 which verifies the absence or presence of an object in the vicinity of the trajectory or path of the tail gate 12 to prevent injury to such object and, in particular, an overhead obstruction such as a garage door, parking structure roof, or the like.

The key fob 8, which is ordinarily push button operated, includes a short-range RF transmitter for communicating with a vehicular body control module for controlling the movement of a vehicular tail gate 12.

As described above and as is known to those skilled in the art, when the push button is depressed on the key fob 8, it actuates an RF transmitter which then sends a data stream created by the RF transmitter to an antenna mounted on the vehicle which in tur, performs the tail gate function based upon the input from a sensor.

In other words, a data stream is a pre-encoded signal (modulation signal) which is sent to the body control module (BCM) equipped with a radio frequency (RF) receiver as at 22. If the transmitted RF code matches that of the RF receiver, then it starts the action of attempting to open the tail gate. If there is no action, then there is no actuation and in lieu thereof, an alarm is sounded to notify the user of an object in the vicinity of the tail gate.

The present invention further includes means for actuating an audible alarm to notify the user that an object is in the path of the trajectory of the tail gate.

More particularly and as shown, the present invention is associated with a vehicle 20 having a tail gate 12 equipped with a smart entry system which can be actuated through the key fob 8.

As described in the aforementioned co-pending application, typically, these vehicles are equipped with the body control module (BCM) and an antenna 60 disposed proximate the rear of the vehicle. The body control module regulates the opening and closing of the tail gate 12.

Object detection per se is achieved through the use of the various ultrasonic sensors 14 and 100 that are mounted in the rear bumper of the vehicle 20, and the tailgate, itself, and which communicates with the fob. The sensors used herein may comprise either(a) transceivers using only I/O pin (TX/RX), or (b) transducers which uses two I/O pins identified as TRIGGER(TX) and ECHO(RX), respectively. It should be noted that, alternatively, radars or cameras working in conjunction with lidars or the like may be used as object detection or proximity sensors, including overhead objects or obstructions such as parking deck roofs, garage doors, etc.

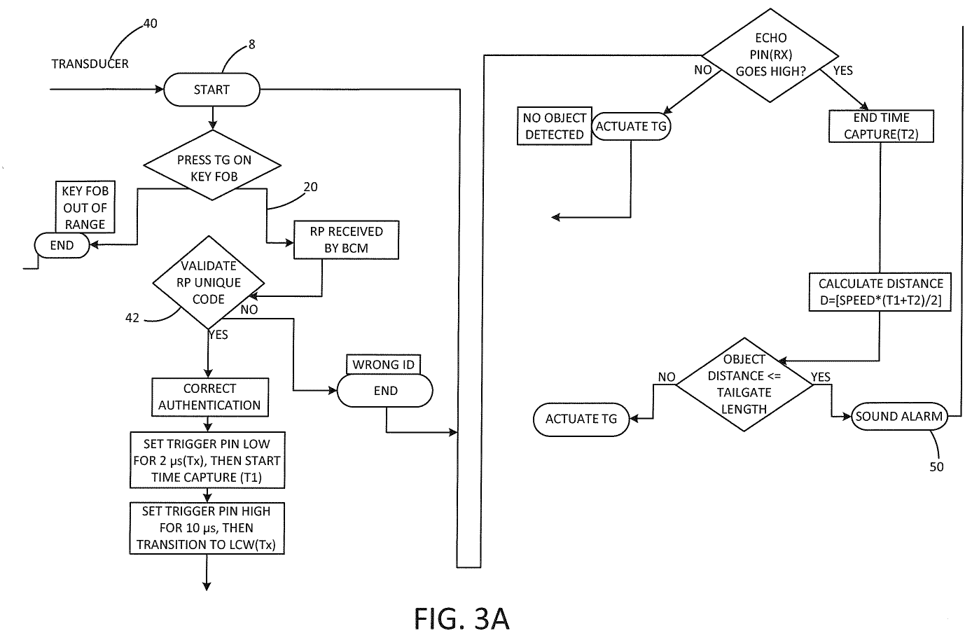

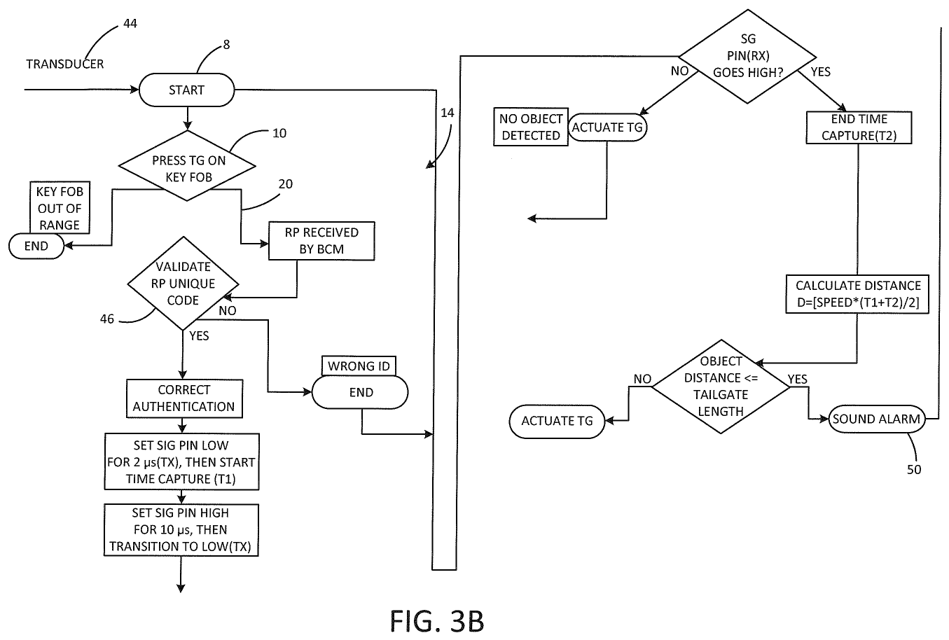

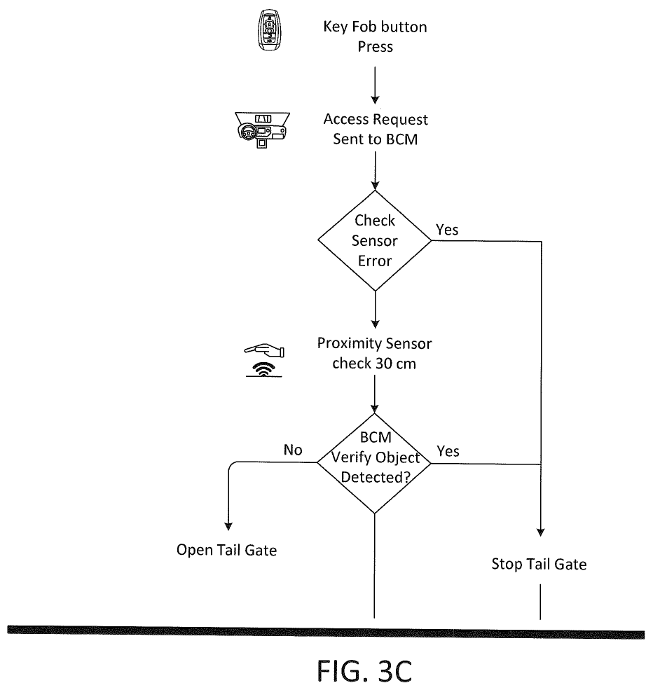

In use and as described in the aforementioned prior application with respect to the typical volume sensed by the sensors 14 and as shown in the data flow of FIG. 3A and assuming the fob has a transmitter 40 incorporated thereinto the key fob 8 only becomes actuable when in a pre-set range to send a signal to the Body Control Module which, in turn, validates the radio frequency (RF) signal sent by the fob, as at 42. If there is no match, then nothing occurs. If there is a match, then a pre-set trigger or echo pin operates between a low point and a high point. Similarly, and as shown, if the key fob is out of range, nothing happens.

With a transceiver 44, a burst of pulses is sent from the fob. If it bounces off the object then the echo is received on the same I/O line.

Regarding the I/O pin with one I/O Sig line, it is initiated by beginning a time capture (T1) while sending a burst of pulses. After the burst the time capture begins, followed by a latency. If an object is detected as at 46, the wave bounces off the object, which drives the same I/O Sig pin LOW-HIGH. A time capture (T2) ends at this sequence. Calculating the distance according to the formula of ((T1+T2)*Speed/2), (i.e., for ultrasonic the speed of sound is used, for a Lidar or Radar sensor the speed of light is used).

Alternatively, and as shown in FIG. 3B in utilizing the transducer 44 with two I/O lines, if a transducer is used one pin is used as the trigger pin (Tx) and the other pin is designated as the receiving echo line (RX) this first line sets the time capture (T1) as it utilizes one of its I/O pins to drive the trigger I/O pin LOW-HIGH by dispersing a multitude of pulses, followed by a latency, which, then, if it detects an object, then the echo pin (RX) data line is driven from LOW-HIGH. This is where time capture ends (T2). In either scenario the same distance formula is used to get the time of flight which is I.E. [(T1+T2)*Speed/2].

If the distance indicates that the tail gate will encounter the object, an alarm 50 is sounded to alert the operator to stop the tail gate from lifting. If not, then the tail gate is actuated to either open or close.

However, the sensors hereof also include ADA warning technology using ultrasonic sensors and which includes parking assist. Thus, when a user shifts the vehicle transmission into the reverse position and begins to back up, the sensors send out ultrasonic waves that bounce off an object when an object is detected in the rear trajectory of the vehicle. This information is reported to the body control module. The sensors and body control module work in parallel. Thus, when an object is detected within a given range, the body control module sends out a CAN object detected signal to the instrument cluster to sound the audible alarm whose alarm volume is contingent upon how close the object is when the vehicle moves in reverse. The closer the object is, the louder the alarm volume.

The implementation of the sensing associated with the key fob as described in the co-pending application requires modification of the key fob. While the invention is efficacious from a commercial standpoint, it becomes difficult to implement. Applying these same principles of sensing, the present invention provides a control and warning system to a user if a trunk lid or tail gate is in proximity to an overhead obstruction. Thus, according hereto, the sensor 100, similar to the sensors 14, is secured to the exterior of the vehicle and is in electrical communication with the BCM.

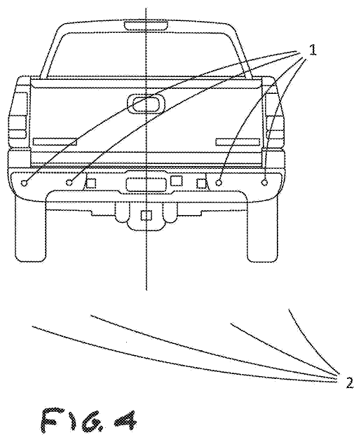

The sensor 100 is a proximity sensor to determine whether or not when the tail gate is lifted if it will encounter an overhead obstruction. It can be preset to a predetermined lift distance. For example, and as shown in FIG. 4 if, when the fob is actuated, the proximity sensor determines whether or not the orbital path of the tail gate will come within a preset, predetermined distance, e.g., less than 12 inches.

Alternatively, the proximity sensor may comprise a combination of an ultrasonic sensor as well as infrared radar or Lidar sensor. This combination improves reliability in all weather conditions.

As the flow chart indicates, if the overhead obstruction is detected within the predetermined distance, the tail gate will not pass therebeyond, the tail gate will not lift, and an alert is sounded. If the pathway is clear, then the tail gate will proceed to open.

In programing the BCM, means, such as an Arduino code, including, for example, Arduino Uno or Arduino Nano. Preferably, Uno is employed herein. As is known to the skilled artisan, Arduinos are open-source boards or hardware which include the requisite software. Here, the code uses a trigger pin which is programmed to have an echo pin and is used to define the safe distance which, for example and as noted, is about 12 inches. The BCM also includes means, such as a relay module which controls means for lifting a tail gate, typically, a motor.

The data stream is a pre-encoded signal which is coded into the circuit board or CPU of the vehicle's BCM to accommodate the overhead obstruction detecting aspect hereof.

With respect to the sensor mounted on the lift gate itself, as with the rear sensors located on the bumper, here, when the push button on the key fob is pressed, it actuates the RF transmitter which then sends the data stream to the BCM, which is equipped with a radio frequency receiver. If the RF code matches that of the RF receiver, then it starts the action of attempting to open the tail gate. If there is no action, then there is no actuation and in lieu thereof, an alarm is sounded to notify the user that there is an overhead obstruction.

It is also contemplated herein and as shown in FIG. 3C, the BCM may include means for signaling a sensor fault to both the BCM, as well as the fob, itself.

It should be noted that although the present invention has been described with reference to a vehicle tailgate, it is equally applicable to a vehicular trunk lid.

It is to be appreciated that the present invention is integrated into present day combined lane change assist and rear, cross-traffic alert functionality such as disclosed in U.S. Pat. No. 8,965,678 and U.S. Patent Publication No. US2012/0041632-A1, the disclosures of which are hereby incorporated by reference.

What is claimed is:

1. A system for preventing a vehicular lift gate from contacting an overhead object when the lifting of the lift gate is initiated by a remote control key fob comprising:
(a) a key fob for transmitting a data stream to open a lift gate;
(b) a vehicular body control module for receiving the data stream to determine the proximity of a lift gate to an overhead obstruction, the module including (1) means for sending a signal to a proximity sensor mounted on a vehicle for determining the proximity of a lift gate to a pre-set distance to an overhead obstruction (2) means for receiving a responsive signal from the sensor and (3) means for actuating an alarm if an overhead obstruction is within the pre-set distance from the lift gate;
(c) a proximity sensor on the vehicle for receiving the signal from the body control module and which sends a return signal to the body control module indicating the lift gate proximity to an obstruction to determine whether or not to open the lift gate and
wherein, the body control module controls lifting of the lift gate, prevents lifting and interrupts the path of travel of the lift gate responsive to the signal from the sensor.

2. The system of claim 1, wherein
the proximity sensor is mounted on the lift gate of a vehicle.

3. The system of claim 1, wherein
the body control module includes open-source software selected from the group of Arduino Uno or Arduino Nano.
